(19) United States
(12) Patent Application Publication
(10) Pub. No.: US 2013/0126315 A1
(43) Pub. Date: May 23, 2013

(54) SWITCH

(71) Applicants: Kokichi Tobita, Kyoto (JP); Kazuaki Morita, Kyoto (JP)

(72) Inventors: Kokichi Tobita, Kyoto (JP); Kazuaki Morita, Kyoto (JP)

(73) Assignee: OMRON CORPORATION, KYOTO (JP)

(21) Appl. No.: 13/321,614

(22) PCT Filed: Mar. 16, 2011
(86) PCT No.: PCT/JP2011/056233

§ 371 Date: Jan. 26, 2012

(30) Foreign Application Priority Data
Dec. 3, 2010 (JP) 2010-270713

(51) Int. Cl. H01H 9/00

(52) U.S. Cl. CPC H01H 9/00
USPC 200/47

(57) ABSTRACT

A switch provided with an actuation body to be displaced due to contact with a physical body and operated in accordance with a position of the actuation body includes a mode switching unit (125) for switching a mode to any of a learning mode and a prediction mode, a position detecting unit (121) for detecting at least preliminarily fixed first and second positions of the actuation body (7), a time measuring unit (127) for measuring a time from when the first position is detected until when the second position is detected, a reference time setting unit (131) for setting a reference time based on the time measured in the learning mode, a comparing unit (133) for comparing the measured time and the reference time in the prediction mode, and a notifying unit (135) for notifying of an alarm in a case where the measured time is greater than the reference time in the prediction mode as a result of comparison. Thereby, the switch capable of being applied to a change in moving speed due to a change in a production line or the physical body or the like and reliably grasping slowing-down of the moving speed of the actuation body over a long time can be provided.

### TECHNICAL FIELD

The present invention relates to a switch provided with an actuation body to be displaced due to contact with a physical body and operated in accordance with a position of the actuation body.

### BACKGROUND ART

Conventionally, there is a known limit switch used for automatically starting up a processing machine in a production line of a factory upon detecting that a physical body such as a product to be processed moves to a predetermined position (refer to Non-patent Document 1). This limit switch is provided with an actuation body to move due to contact with the physical body and operated in accordance with a position of the actuation body. This actuation body is attached to a rotation shaft provided in a main body of the switch to thereby be rotatable on the rotation shaft. A position of the actuation body in a state where the actuation body is not in contact with the physical body is a fixed position, and the actuation body is rotated from the fixed position to a position in accordance with size of the physical body upon contact with the physical body. Thereafter, the actuation body is returned to the fixed position upon being brought away from the physical body.

Regarding such a limit switch, the following techniques are described in Patent Documents 1 and 2. A limit switch is provided with at least a first switch unit, a second switch unit which is more slowly returned than the first switch unit, and a timer for measuring a time. When such a limit switch is brought into contact with a physical body to be moved, the first switch unit and the second switch unit are turned into an ON state. After that, after the switch is no more in contact with the physical body and the first switch unit is turned into an OFF state, the second switch unit is turned into the OFF state. The timer measures a time from when the first switch unit is turned into the OFF state until when the second switch unit is turned into the OFF state. Thereby, a returning time of the limit switch is measured. In a case where the measured returning time is longer than a time-up time, an alarm is issued.

It should be noted that in Patent Document 1, a reference set time is updated by obtaining an average between a reference set time corresponding to a previous time-up time and a present measured time. A time obtained by adding a predetermined time to the updated reference set time is set as a next time-up time. In Patent Document 2, a time-up time is preliminarily fixed.

### CITATION LIST

### Patent Document

PATENT DOCUMENT 1: Japanese Unexamined Patent Publication No. 2-281513 (published on Nov. 10, 1990)
PATENT DOCUMENT 2: Japanese Unexamined Patent Publication No. 64-43934 (published on Feb. 16, 1989)

### Non-patent Document

Non-patent Document 1: OMRON Corporation “Limit switch technical guide”, http://www.fa.omron.co.jp/data_pdf/commentary/limitswitch_apparatus_tg_j_{—}3_{—}1_{—}1-5.pdf, Nov. 19, 2010

### SUMMARY OF THE INVENTION

### Problems to be Solved by the Invention

When a production line in which a limit switch is installed is changed or a type of a physical body to be moved is changed, there is a possibility that moving speed of an actuation body is changed. Therefore, there is a need for changing a time-up time to be compared in order to issue an alarm. However, in the technique of Patent Document 2, the time-up time is preliminarily fixed. Thus, there is a problem that the technique cannot cope with a change in the production line or the physical body. In the technique of Patent Document 1, the next time-up time is set with using the previous reference set time and the present measured time. Thus, the technique can cope with the change in the production line or the physical body to some extent.

However, in a case where the switch is used for a long time, there is a possibility that frictional force between the actuation body and a rotation shaft thereof is gradually increased due to some influences. In this case, it is thought that the moving speed of the actuation body is gradually slowed down. In such a case where the moving speed is gradually slowed down over a long time, when a certain limit is exceeded, an error that a next physical body cannot be detected or the like is generated. However, in the technique described in Patent Document 1, the time-up time is updated with a time obtained by adding a predetermined time to the average time between the measured speed and the previous reference set time for every measurement. Therefore, in a case where the moving speed of the actuation body is gradually slowed down as described above, the time-up time is set so as to be gradually increased. As a result, the fact that the moving speed is gradually slowed down over a long time cannot be detected only by comparing the time-up time and the measured time.

The present invention is achieved in order to solve the above problems, and an object of the invention is to provide a switch capable of detecting slowing-down of moving speed of an actuation body, the switch being capable of being applied to a change in the moving speed due to a change in a production line or a physical body or the like and reliably grasping the slowing-down of the moving speed of the actuation body over a long time.

### Means for Solving the Problem

In order to solve the above problems, a switch of the present invention provided with an actuation body to be displaced due to contact with a physical body and operated in accordance with a position of the actuation body includes a mode switching means for switching a mode to any of a learning mode and a prediction mode, a position detection means for detecting at least preliminarily fixed first and second positions of the actuation body, a time measurement means for measuring a time from when the first position is detected by the position detection means until when the second position is detected by the position detection means, a reference time setting means for setting a reference time based on the time measured by the time measurement means in the learning mode, a comparison means for comparing the time measured by the time measurement means and the reference time in the prediction mode, and a notification means for notifying of an alarm in a case where the measured time is greater than the reference time as a result of comparison by the comparison means in the prediction mode.

According to the above configuration, the time from when the first position is detected until when the second position is detected is measured, and the reference time is set based on the time measured in the learning mode. The measured time and the reference time are compared in the prediction mode. In a case where the measured time is greater than the reference time as a result of the comparison, the alarm is notified. Thereby, while confirming that the physical body is normally brought into contact with the actuation body immediately after a change in a production line or a change in a type of the physical body to be moved, a user can set the mode to the learning mode with using the mode switching means. Thereby, the reference time can be set when the actuation body is normally operated. The reference time is automatically set based on the measured time from when the first position is detected until when the second position is detected in the learning mode. Thus, setting of the reference time can be simplified. In such a way, even when moving speed is changed due to the change in the production line or the physical body or the like, the user can easily re-set the reference time to be used by the comparison means.

Further, as described above, the mode is switched to the learning mode in accordance with a user input, for example, immediately after the change in the production line or the change in the type of the physical body to be moved. The reference time is set only in the learning mode. As a result, even in a case where the moving speed is gradually slowed down over a long time, slowing-down of a moving time can be reliably detected, and the alarm can be notified. Therefore, the user can recognize that the moving speed of the actuation body is gradually slowed down over a long time.

In such a way, according to the present invention, the switch capable of being applied to the change in the moving speed due to the change in the production line or the physical body or the like, and reliably grasping the slowing-down of the moving speed of the actuation body over a long time can be provided.

### Effect of the Invention

According to the present invention, there is an effect of providing the switch capable of being applied to the change in the moving speed due to the change in the production line or the physical body or the like and reliably grasping the slowing-down of the moving speed of the actuation body over a long time.

### BRIEF DESCRIPTION OF THE DRAWINGS

FIG. 1 is a perspective view showing a limit switch in the present embodiment.

FIG. 2 is a view showing a switch module provided in the limit switch.

FIG. 3 is a perspective view when the switch module is disassembled.

FIG. 4 is a perspective view showing a photointerrupter unit provided in the switch module together with a substrate.

FIG. 5 is a view showing a front surface of a plunger provided in the switch module.

FIG. 6 is a perspective view of the plunger seen from the front surface side.

FIG. 7 is a view showing a back surface of the plunger.

FIG. 8 is a perspective view of the plunger seen from the back surface side.

FIG. 9 is a view showing a cross section of the plunger.

FIG. 10 is a first view showing a positional relationship among a plurality of light emitting elements, a plurality of light receiving elements, and the plunger in a cross section of the switch module.

FIG. 11 is a second view showing a positional relationship among the plurality of light emitting elements, the plurality of light receiving elements, and the plunger in the cross section of the switch module.

FIG. 12 is a third view showing a positional relationship among the plurality of light emitting elements, the plurality of light receiving elements, and the plunger in the cross section of the switch module.

FIG. 13 is a fourth view showing a positional relationship among the plurality of light emitting elements, the plurality of light receiving elements, and the plunger in the cross section of the switch module.

FIG. 14 is a fifth view showing a positional relationship among the plurality of light emitting elements, the plurality of light receiving elements, and the plunger in the cross section of the switch module.

FIG. 15 is a block diagram showing a configuration of the switch module.

FIG. 16 is a view showing relationships between an angle of an actuation body and output voltages of the light receiving elements.

FIG. 17 is a view showing a front surface of a plunger in a modified example.

FIG. 18 is a perspective view of the plunger in the modified example seen from the front surface side.

FIG. 19 is a view showing a back surface of the plunger in the modified example.

FIG. 20 is a perspective view of the plunger in the modified example seen from the back surface side.

FIG. 21 is a view showing a cross section of the plunger in the modified example.

FIG. 22 is a first view showing a positional relationship among the plurality of light emitting elements, the plurality of light receiving elements, and the plunger in the modified example in the cross section of the switch module.

FIG. 23 is a second view showing a positional relationship among the plurality of light emitting elements, the plurality of light receiving elements, and the plunger in the modified example in the cross section of the switch module.

FIG. 24 is a third view showing a positional relationship among the plurality of light emitting elements, the plurality of light receiving elements, and the plunger in the modified example in the cross section of the switch module.

FIG. 25 is a fourth view showing a positional relationship among the plurality of light emitting elements, the plurality of light receiving elements, and the plunger in the modified example in the cross section of the switch module.

FIG. 26 is a fifth view showing a positional relationship among n the plurality of light emitting elements, the plurality of light receiving elements, and the plunger in the modified example in the cross section of the switch module.

FIG. 27 is a view showing relationships between the angle of the actuation body and the output voltages of the light receiving elements in the modified example.

### EMBODIMENT FOR CARRYING OUT THE INVENTION

With reference to the drawings, an embodiment of the present invention will be described. In the following description, the same parts will be given the same reference symbols. Names and functions of the parts are also the same. Therefore, detailed description thereof will not be repeated.

<Entire Configuration of Limit Switch>

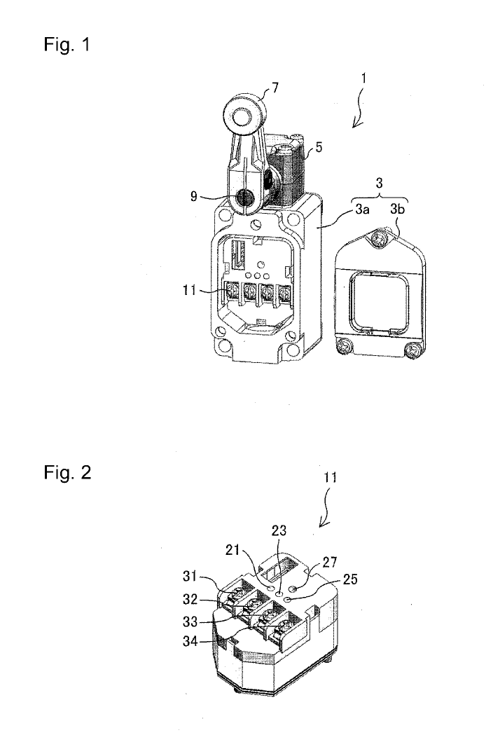

FIG. 1 is a perspective view showing a limit switch in the present embodiment. The limit switch is a switch for detecting a position, change, movement, passage, or the like, and outputting an ON signal or an OFF signal in accordance with detection or non-detection. Considering that the limit switch of the present embodiment is applied to a place where mechanical strength and environmental resistance are required, the limit switch is preferably formed to be protected from external force, water, oil, gas, grit and dust, and the like.

As shown in FIG. 1, a limit switch 1 is provided with at least a casing 3, an installment block 5, and an actuation body 7.

The casing 3 in which a switch module 11 is disposed in an internal space thereof is to protect the switch module 11 from the external force, the water, the oil, the gas, the grit and the dust, and the like. The casing 3 includes a casing main body 3a having an opening for assembling the switch module 11 into the internal space, and a lid portion 3b for closing the opening.

The installment block 5 is attached to an upper part of the casing 3. The actuation body 7 is rotatably attached to the installment block 5 by a screw 9.

The actuation body 7 protrudes from the installment block 5, and a position thereof when the actuation body is not in contact with a physical body and force is not applied from an exterior is a fixed position. The fixed position of the actuation body 7 is shown as a position where the actuation body is directed in 0 o'clock of a watch. In FIG. 1, the actuation body 7 is rotated clockwise on the screw 9 when the force is applied from the left side, and after that, returned to the fixed position when the force is removed. Meanwhile, the actuation body 7 is rotated anti-clockwise on the screw 9 when the force is applied from the right side, and after that, returned to the fixed position when the force is removed. It should be noted that hereinafter, a position of the actuation body is indicated by an angle from the fixed position. As described later, setting is made in such a manner that the switch module 11 is operated by rotation of the actuation body 7.

It should be noted that seal members are disposed at connection points of the casing main body 3a, the lid portion 3b, the installment block 5, and the actuation body 7, so as to prevent intrusion of the water, the oil, the gas, and the like.

<Configuration of Switch Module>

As described above, the switch module is disposed in the internal space of the casing 3. This switch module 11 is to output various signals in accordance with the position of the actuation body 7.

FIG. 2 is a view showing an outer appearance of the switch module. As shown in FIG. 2, the switch module 11 is provided with a microcomputer (not shown) for controlling the entire switch module 11, lighting units 21, 23, 25, a mode switch 27, and terminals 31 to 34.

The mode switch 27 is a switch for switching a mode to any of a prediction mode and a learning mode, and has a button to be pressed by a user. The learning mode is a mode for storing a time of the actuation body 7 required for returning from a preliminarily fixed first position to a preliminarily fixed second position as a reference time T in the limit switch 1. However, the angle of the actuation body 7 at the first position is larger than the angle of the actuation body 7 at the second position. The prediction mode is a mode for, in a case where there is a possibility that a failure or an abnormality would occur in the future in the limit switch 1, notifying that there is the possibility.

The terminals 31, 32 are terminals to be connected to a device for supplying electric power. The terminals 33, 34 are terminals to be connected to a device used for tasks in a production line. The microcomputer provided in the switch module 11 controls the entire switch module 11 and outputs the ON signal indicating that the limit switch 1 is in an ON state to the exterior via the terminal 33 when the angle of the actuation body 7 is not less than the angle specified by a preliminarily fixed third position. The ON signal is utilized as a signal for driving an external device. The microcomputer provided in the switch module 11 outputs the OFF signal indicating that the limit switch 1 is in an OFF state to the exterior via the terminal 33 when the angle of the actuation body 7 is less than the angle specified by the third position.

The microcomputer outputs a signal indicating failure prediction serving as a function of the switch module 11 to the exterior via the terminal 34.

The lighting unit 23 emits light upon the supply of the electric power from the exterior, and specifically is a power supply lamp. The lighting unit 21 is controlled by the microcomputer, and emits the light when the limit switch 1 is in the ON state and does not emit the light when the limit switch 1 is in the OFF state. The lighting unit 25 is controlled by the microcomputer, and emits the light when a failure prediction signal is outputted and does not emit the light when the failure prediction signal is not outputted. It should be noted that the lighting units 21, 23, 25 are formed by an LED (Light Emitting Diode) lighting circuit, and a light guide rod for guiding the light emitted from the LED lighting circuit to a surface of the switch module 11.

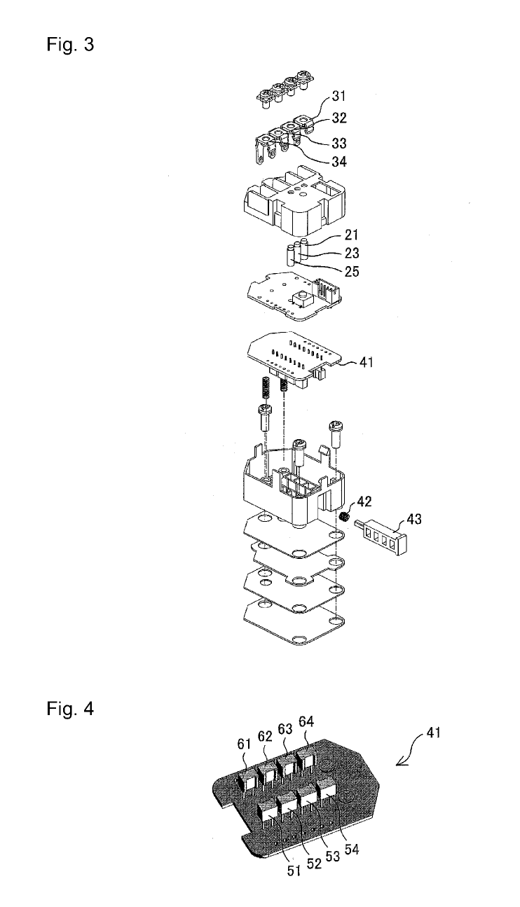

FIG. 3 is a perspective view when the switch module is disassembled. As shown in FIG. 3, in addition to the terminals 31 to 34 and the lighting units 21, 23, 25, the switch module 11 is provided with a photointerrupter unit 41 serving as an optical sensor, a coil spring 42, and a plunger 43.

The photointerrupter unit 41 has a plurality of light emitting elements and light receiving elements. The light emitting elements emit light with high linearity, and, for example, are light emitting diodes. The light receiving elements are, for example, single phototransistors, photo ICs, or photodiodes.

The plunger 43 is a rod shape mechanical part, and has a plurality of slits (openings). The plunger 43 can be moved in parallel in the longitudinal direction of the plunger 43 in conjunction with movement of the actuation body 7. That is, the plunger 43 is a displacement member to be displaced in accordance with a load of the force from the exterior. It should be noted that various known techniques can be used as a mechanism of moving the plunger 43 in conjunction with the movement of the actuation body 7. Here, as described in Patent Document 1, part of a rotation shaft of the actuation body 7 is formed into a flat shape, and the flat part and one end in the longitudinal direction of the plunger 43 are formed to be brought into contact with each other. A position of the plunger 43 when the actuation body 7 is placed at the fixed position (that is, in a state where the actuation body 7 is not in contact with the physical body and not rotated) and the flat part and the plunger 43 are brought into contact with each other is a reference position. In this case, the flat part is also rotated by the rotation of the actuation body 7, so that the force can be applied to the plunger 43 in the longitudinal direction of the plunger 43. As a result, the plunger 43 is displaced from the reference position along the longitudinal direction thereof. Bias force for returning to the reference position is applied to the plunger 43 by the coil spring 42. Therefore, when the actuation body 7 is returned to the fixed position, the plunger 43 is also returned to the reference position by the bias force of the coil spring 42.

FIG. 4 is a perspective view showing the photointerrupter unit together with a substrate. As shown in FIG. 4, the photointerrupter unit 41 includes light emitting elements 51 to 54 having the same shape and the same size, and light receiving elements 61 to 64 having the same shape and the same size as the light emitting elements 51 to 54. Here, it should be noted that although the light emitting elements 51 to 54 and the light receiving elements 61 to 64 have the same shape and the same size, the shape and the size are not necessarily all the same.

The light emitting elements 51 to 54 and the light receiving elements 61 to 64 are disposed on the same straight line along the longitudinal direction of the plunger 43. A light emitting part (a light emitting surface) of the light emitting element 51 faces a light receiving part (a light receiving surface) of the light receiving element 61. Similarly, a light emitting part (a light emitting surface) of the light emitting element 52 faces a light receiving part (a light receiving surface) of the light receiving element 62, a light emitting part (a light emitting surface) of the light emitting element 53 faces a light receiving part (a light receiving surface) of the light receiving element 63, and a light emitting part (a light emitting surface) of the light emitting element 54 faces a light receiving part (a light receiving surface) of the light receiving element 64. Therefore, the light receiving elements 61 to 64 can receive the lights emitted by the light emitting elements 51 to 54 by a one-to-one relationship. That is, the light emitting element 51 and the light receiving element 61 form one photointerrupter for detecting existence or non-existence of the physical body between the light emitting element 51 and the light receiving element 61. Similarly, each of a combination of the light emitting element 52 and the light receiving element 62, a combination of the light emitting element 53 and the light receiving element 63, and a combination of the light emitting element 54 and the light receiving element 64 serves as one photointerrupter.

The light emitting elements 51 to 54 and the light receiving elements 61 to 64 are disposed so as to be spaced from each other by a distance being width in the short direction of the plunger 43, or a distance slightly larger than the width. Thereby, the plunger 43 can be disposed between the light emitting elements 51 to 54 and the light receiving elements 61 to 64. By this arrangement, the plunger 43 moves in parallel in the perpendicular direction to the direction in which the light emitting elements 51 to 54 and the light receiving elements 61 to 64 respectively face each other in conjunction with the movement of the actuation body 7.

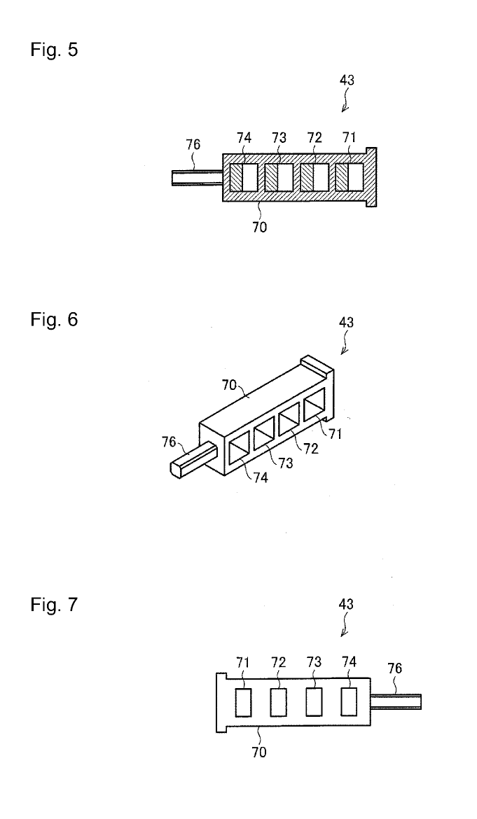

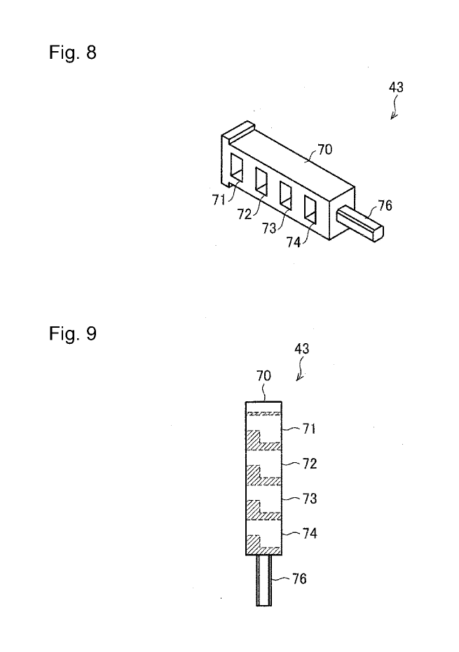

FIG. 5 is a view showing a front surface of the plunger. FIG. 6 is a perspective view of the plunger seen from the front surface side. FIG. 7 is a view showing a back surface of the plunger. FIG. 8 is a perspective view of the plunger seen from the back surface side thereof. FIG. 9 is a view showing a cross section of the plunger. As shown in FIGS. 5 to 9, the plunger 43 has a main body portion 70 and a projection portion 76. The projection portion 76 is combined with the main body portion 70 and is thinner than the main body portion 70. The projection portion 76 is inserted into the coil spring 42.

The main body portion 70 has slits (openings) 71 to 74. Here, since shapes of the slits 71 to 74 are the same, the slit 71 will be described. An opening of the slit 71 has different sizes respectively for the front surface and the back surface of the plunger 43. Specifically, a shape of the opening of the slit 71 in the cross section is a shape of regions not indicated by diagonal lines among a region surrounded by broken lines as shown in FIG. 9. The size of the opening of the slit 71 on the front surface of the plunger 43 is set to be larger than the size of the opening of the slit 71 on the back surface of the plunger 43.

<Positional Relationship between Photointerrupter and Plunger>

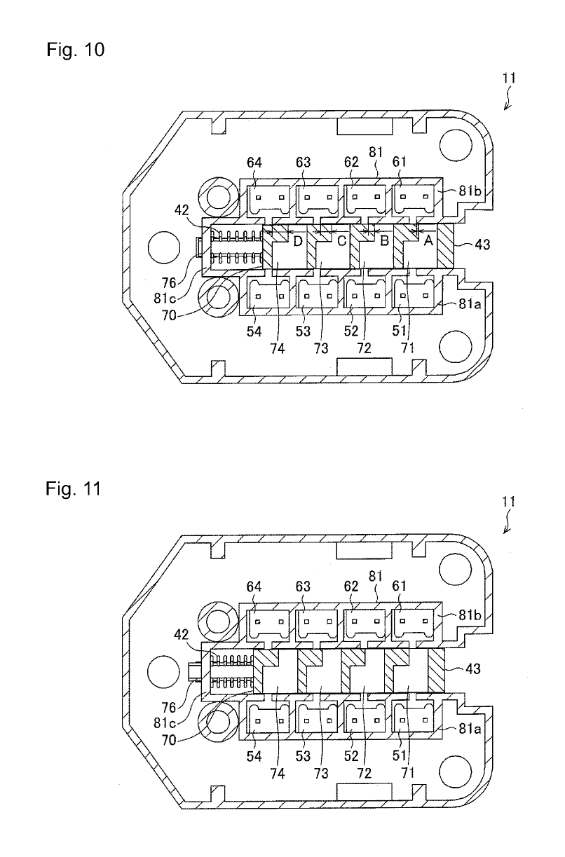

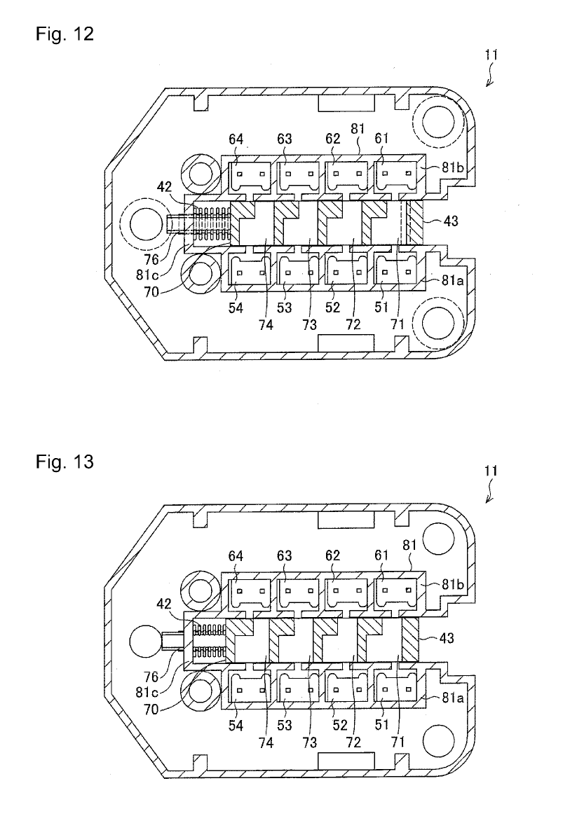

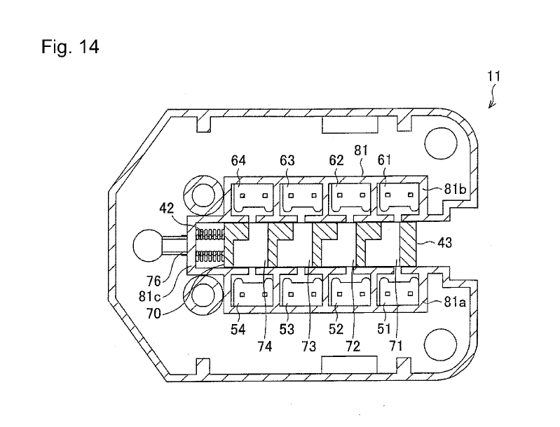

FIGS. 10 to 14 are views showing positional relationships among the plurality of light emitting elements, the plurality of light receiving elements, and the plunger in a cross section of the switch module. It should be noted that FIG. 10 is a view when the actuation body 7 is placed at the fixed position, FIG. 11 is a view when the actuation body 7 is placed at a position of 15 degrees (that is, a position where the actuation body is rotated by 15 degrees from the fixed position), FIG. 12 is a view when the actuation body 7 is placed at a position of 22.5 degrees, FIG. 13 is a view when the actuation body 7 is placed at a position of 30 degrees, and FIG. 14 is a view when the actuation body 7 is placed at a position of 42.5 degrees. Here, positions at which the light emitting elements 51 to 54 and the light receiving elements 61 to 64 are disposed are as shown in FIG. 4.

As shown in FIGS. 10 to 14, the switch module 11 is provided with a partition plate 81. The partition plate 81 is a plate for partitioning the light emitting elements 51 to 54, the light receiving elements 61 to 64, and the plunger 43. Specifically, the partition plate 81 is provided with a first partition plate 81a for partitioning the light emitting elements 51 to 54 and the plunger 43, a second partition plate 81b for partitioning the light receiving elements 61 to 64 and the plunger 43, and a third partition plate 81c placed between the first partition plate 81a and the second partition plate 81b. The plunger 43 is disposed between the first partition plate 81a and the second partition plate 81b. The back surface of the plunger 43 is adjacent to the second partition plate 81b, and the front surface of the plunger 43 is adjacent to the first partition plate 81a. That is, the front surface of the plunger 43 faces the light emitting elements 51 to 54, and the back surface of the plunger 43 faces the light receiving elements 61 to 64. It should be noted that as shown in FIG. 5, a part of the main body portion 70 of the plunger 43 other than the slits 71 to 74 is indicated by diagonal lines. Hereinafter, the part of the diagonal lines will be a light blocking region.

The first partition plate 81a partitions each of the light emitting elements 51 to 54, and the second partition plate 81b partitions each of the light receiving elements 61 to 64. The first partition plate 81a has a plurality of openings corresponding to the positions at which the light emitting elements 51 to 54 are respectively disposed. Specifically, the plurality of openings provided in the first partition plate 81a is respectively placed at positions where the lights respectively emitted by the light emitting elements 51 to 54 can pass through. The second partition plate 81b has a plurality of openings corresponding to the positions at which the light receiving elements 61 to 64 are respectively disposed. Specifically, the plurality of openings provided in the second partition plate 81b is respectively placed at positions where the light receiving elements 61 to 64 can respectively receive the light from the light emitting elements 51 to 54. Therefore, regions linearly connecting the openings formed in the first partition plate 81a and the openings formed in the second partition plate 81b corresponding to the above openings are regions through which the lights emitted from the light emitting elements pass (light path regions).

Further, the third partition plate 81c has a hole through which only the projection portion 76 of the plunger 43 is inserted. Therefore, the coil spring 42 into which the projection portion 76 is inserted exists between the third partition plate 81c and the main body portion 70. When the plunger 43 moves in parallel toward the third partition plate 81c in accordance with the movement of the actuation body 7, the coil spring 42 is compressed between the main body portion 70 of the plunger 43 and the third partition plate 81c so as to give force of returning the plunger 43 to the reference position to the plunger 43.

As described above, the plunger 43 moves in the longitudinal direction thereof in conjunction with the movement of the actuation body 7. In the middle of this movement, the slit 71 is formed in the plunger 43 in such a manner that the slit 71 is overlapped with the opening of the first partition plate 81a corresponding to the light emitting element 51 and the opening of the second partition plate 81b corresponding to the light receiving element 61. Similarly, the slit 72 is formed in the plunger 43 in such a manner that the slit 72 is overlapped with the opening of the first partition plate 81a corresponding to the light emitting element 52 and the opening of the second partition plate 81b corresponding to the light receiving element 62. The slit 73 is formed in the plunger 43 in such a manner that the slit 73 is overlapped with the opening of the first partition plate 81a corresponding to the light emitting element 53 and the opening of the second partition plate 81b corresponding to the light receiving element 63. Further, the slit 74 is formed in the plunger 43 in such a manner that the slit 74 is overlapped with the opening of the first partition plate 81a corresponding to the light emitting element 54 and the opening of the second partition plate 81b corresponding to the light receiving element 64. In such a way, the slits 71 to 74 respectively correspond to the light emitting elements 51 to 54 and the light receiving elements 61 to 64.

However, a distance between each of the openings on the back surface side of the slits 71 to 74 and each of the openings of the second partition plate 81b corresponding to the slits is different among the slits 71 to 74. Specifically, as shown in FIG. 10, positions of the slits 71 to 74 are set in such a manner that when the actuation body 7 is placed at the fixed position (that is, when the plunger 43 is placed at the reference position), the distance is gradually increased in the order of a distance A between the opening on the back surface side of the slit 71 and the opening of the second partition plate 81b corresponding to the slit 71, a distance B between the opening on the back surface side of the slit 72 and the opening of the second partition plate 81b corresponding to the slit 72, a distance C between the opening on the back surface side of the slit 73 and the opening of the second partition plate 81b corresponding to the slit 73, and a distance D between the opening on the back surface side of the slit 74 and the opening of the second partition plate 81b corresponding to the slit 74.

Here, a position with which a displacement amount from the reference position becomes minimum among positions of the plunger 43 when the light receiving elements 61 to 64 detect the light passing through the slits 71 to 74 serves as a light detection start position. In this case, the above distances A to D indicate distances from the reference position to the light detection start position.

When such a plunger 43 moves in parallel in conjunction with the movement of the actuation body 7, the lights emitted by the light emitting elements 51 to 54 are blocked or pass through in accordance with the position of the plunger. Specifically, when the openings provided in the second partition plate 81b and the light blocking region of the plunger 43 are overlapped by a change in the position of the plunger 43, the plunger 43 blocks the light to the light receiving elements corresponding to the openings. When the openings provided in the second partition plate 81b and the slits of the plunger 43 are at least partially overlapped, the plunger 43 allows the light to pass through to the light receiving elements corresponding to the openings. In other words, when light paths from the light emitting elements 51 to 54 to the light receiving elements 61 to 64 and at least part of the slits 71 to 74 are overlapped, the light passes therethrough. At this time, amounts of the light incident on the light receiving elements are proportional to size of regions where the openings provided in the second partition plate 81b and the openings of the slits are overlapped.

A light to be blocked by the plunger 43 among the lights respectively emitted by the light emitting elements 51 to 54 corresponds to the position of the plunger 43, that is, the angle of the actuation body 7 from the fixed position. Hereinafter, with reference to FIGS. 10 to 15, as the angle of the actuation body 7 from the fixed position is changed, how presence or absence of light incidence on the light receiving elements 61 to 64 and the amounts of the incident light are changed will be described.

As shown in FIG. 10, the plunger 43 blocks all the lights emitted by the light emitting elements 51 to 54 when the actuation body 7 is placed at a position of 0 degree (the fixed position). Specifically, the light blocking region of the plunger 43 covers all the openings corresponding to positions at which the light receiving elements 61 to 64 are disposed in the second partition plate 81b. Therefore, the lights respectively emitted by the light emitting elements 51 to 54 is blocked by the plunger 43 and does not reach the light receiving elements 61 to 64.

From a state shown in FIG. 10, the actuation body 7 is rotated, and the plunger 43 is moved in the longitudinal direction thereof. At this time, as described above, the distance A between the opening on the back surface side of the slit 71 and the opening of the second partition plate 81b corresponding to the slit 71 is shorter than the other distances B to D. Thus, only the opening on the back surface side of the slit 71 and the opening of the second partition plate 81b corresponding to the light receiving element 61 start overlapping. Thereafter, when a movement amount of the plunger 43 is increased with an increase in the angle of the actuation body 7, an overlapping region of the opening on the back surface side of the slit 71 and the opening of the second partition plate 81b corresponding to the light receiving element 61 is increased, and the opening on the back surface side of the slit 72 and the opening of the second partition plate 81b corresponding to the light receiving element 62 start overlapping.

As shown in FIG. 11, when the actuation body 7 is placed at the position of 15 degrees, the opening on the back surface side of the slit 71 is overlapped with the entire region of the opening of the second partition plate 81b corresponding to the light receiving element 61. In other words, the opening of the slit 71 is placed all over a space (the light path region) linearly connecting the opening corresponding to the position at which the light emitting element 51 is disposed in the first partition plate 81a and the opening corresponding to the position at which the light receiving element 61 is disposed in the second partition plate 81b. Further, the opening on the back surface side of the slit 72 is overlapped with part of the opening of the second partition plate 81b corresponding to the light receiving element 62. In other words, only part of the opening of the slit 72 is placed in a space (the light path region) linearly connecting the opening corresponding to the position at which the light emitting element 52 is disposed in the first partition plate 81a and the opening corresponding to the position at which the light receiving element 62 is disposed in the second partition plate 81b. Therefore, a light receiving amount of the light receiving element 61 has a maximum value, and the light receiving element 62 receives only part of the light emitted from the light emitting element 52. In this stage, the light blocking region of the plunger 43 still covers the openings of the second partition plate 81b corresponding to the positions at which the light receiving elements 63, 64 are disposed. Thus, the light does not reach the light receiving elements 63, 64.

From a state shown in FIG. 11, the actuation body 7 is further rotated, and the plunger 43 is moved in the longitudinal direction thereof. At this time, when the movement amount of the plunger 43 is increased with the increase in the angle of the actuation body 7, an overlapping region of the opening on the back surface side of the slit 72 and the opening of the second partition plate 81b corresponding to the light receiving element 62 is increased, and the opening on the back surface side of the slit 73 and the opening of the second partition plate 81b corresponding to the light receiving element 63 start overlapping.

As shown in FIG. 12, when the actuation body 7 is placed at the position of 22.5 degrees, the openings on the back surface side of the slits 71, 72 are respectively overlapped with the entire regions of the openings of the second partition plate 81b corresponding to the light receiving elements 61, 62. In other words, the opening of the slit 71 is placed all over the space (the light path region) linearly connecting the opening corresponding to the position at which the light emitting element 51 is disposed in the first partition plate 81a and the opening corresponding to the position at which the light receiving element 61 is disposed in the second partition plate 81b. Similarly, the opening of the slit 72 is placed all over the space (the light path region) linearly connecting the opening corresponding to the position at which the light emitting element 52 is disposed in the first partition plate 81a and the opening corresponding to the position at which the light receiving element 62 is disposed in the second partition plate 81b. In addition, the opening on the back surface side of the slit 73 is overlapped with part of the opening of the second partition plate 81b corresponding to the light receiving element 63. In other words, only part of the opening of the slit 73 is placed in a space (the light path region) linearly connecting the opening corresponding to the position at which the light emitting element 53 is disposed in the first partition plate 81a and the opening corresponding to the position at which the light receiving element 63 is disposed in the second partition plate 81b. Therefore, light receiving amounts of the light receiving elements 61, 62 have maximum values, and the light receiving element 63 receives only part of the light emitted from the light emitting element 53. It should be noted that in this stage, the light blocking region of the plunger 43 still covers the opening of the second partition plate 81b corresponding to the position at which the light receiving element 64 is disposed. Therefore, the light does not reach the light receiving element 64.

When the actuation body 7 is further rotated, and the plunger 43 is moved in the longitudinal direction thereof from a state shown in FIG. 12, an overlapping region of the opening on the back surface side of the slit 73 and the opening of the second partition plate 81b corresponding to the light receiving element 63 is increased.

As shown in FIG. 13, when the actuation body 7 is placed at the position of 30 degrees, the openings on the back surface side of the slits 71, 72, 73 are respectively overlapped with the entire regions of the openings of the second partition plate 81b corresponding to the light receiving elements 61, 62, 63. Therefore, light receiving amounts of the light receiving elements 61, 62, 63 have maximum values. It should be noted that in this stage, the light blocking region of the plunger 43 still covers the opening of the second partition plate 81b corresponding to the position at which the light receiving element 64 is disposed. Therefore, the light does not reach the light receiving element 64.

When the actuation body 7 is further rotated, and the plunger 43 moves in the longitudinal direction thereof from a state shown in FIG. 13, the opening on the back surface side of the slit 74 and the opening of the second partition plate 81b corresponding to the light receiving element 64 start overlapping.

As shown in FIG. 14, when the actuation body 7 is placed at the position of 42.5 degrees, the openings on the back surface side of the slits 71 to 74 are respectively overlapped with the entire regions of the openings of the second partition plate 81b corresponding to the light receiving elements 61 to 64. Therefore, light receiving amounts of the light receiving elements 61 to 64 have maximum values.

<Relationship between Microcomputer and Peripheral Configuration Thereof>

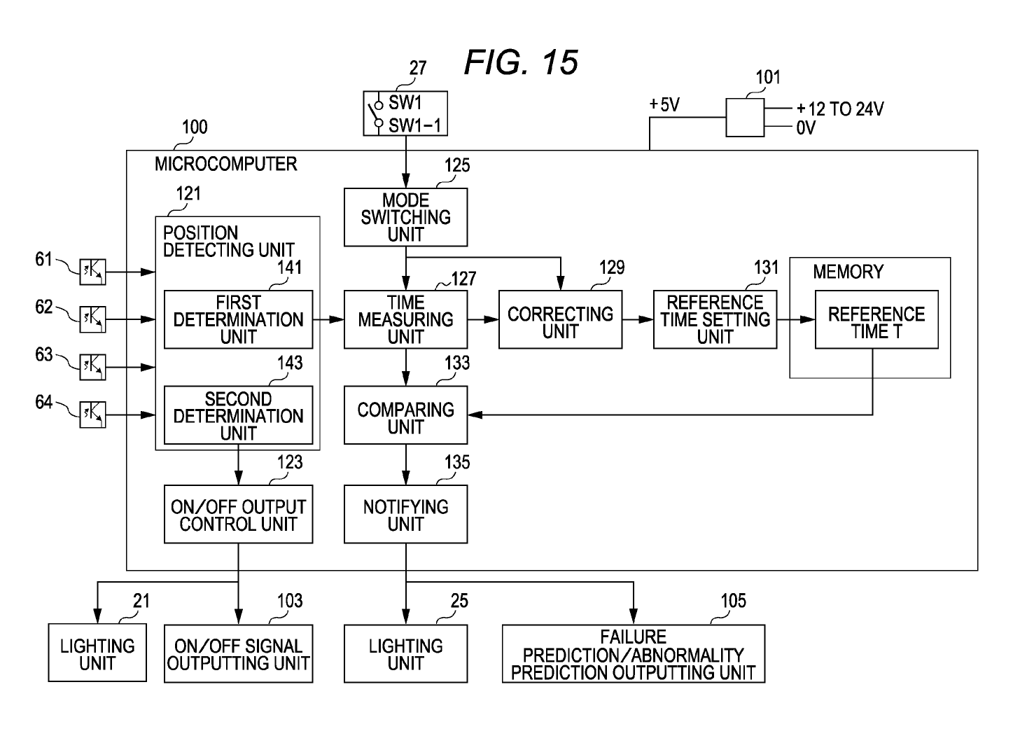

FIG. 15 is a block diagram showing a configuration of the switch module. As shown in FIG. 15, the switch module 11 includes a microcomputer 100 for controlling the entire switch module 11, a low voltage circuit 101, the light receiving elements 61 to 64, an ON/OFF signal outputting unit 103, and a failure prediction/abnormality prediction outputting unit 105 in addition to the mode switch 27, and the lighting units 21, 25.

The low voltage circuit 101 converts a voltage inputted from the exterior, and outputs a voltage lower than the inputted voltage to the microcomputer 100. When the voltage is inputted from the low voltage circuit 101, the microcomputer 100 lights the lighting unit 23 shown in FIG. 2.

The light receiving element 61 outputs a value (a characteristic amount) indicating a voltage in accordance with the amount of the light received from the light emitting element 51 to the microcomputer 100. The light receiving element 62 outputs a voltage in accordance with the amount of the light received from the light emitting element 52 to the microcomputer 100. The light receiving element 63 outputs a voltage in accordance with the amount of the light received from the light emitting element 53 to the microcomputer 100. The light receiving element 64 outputs a voltage in accordance with the amount of the light received from the light emitting element 54 to the microcomputer 100.

As described above, the mode switch 27 is the switch for switching the mode to any of the prediction mode and the learning mode, and has the button to be pressed by the user. When the button is pressed down, the mode switch 27 inputs a LOW signal for switching the mode to the microcomputer 100. Meanwhile, in a case where the button is not pressed down, the mode switch 27 always outputs a HIGH signal to the microcomputer 100.

The ON/OFF signal outputting unit 103 is controlled by the microcomputer 100, so as to output the ON signal or the OFF signal to the external device serving as a control object of the limit switch 1.

The failure prediction/abnormality prediction outputting unit 105 is controlled by the microcomputer 100, so as to output the failure prediction signal indicating that the failure occurs in the limit switch 1 to the exterior. Specifically, the failure is notified when the time of the actuation body 7 for returning from the first position to the second position in the prediction mode is longer than the reference time T stored in the learning mode. The reference time T will be described later.

The lighting unit 21 is controlled by the microcomputer 100, and emits the light when the ON/OFF signal outputting unit 103 outputs the ON signal and does not emit the light when the ON/OFF signal outputting unit outputs the OFF signal.

The lighting unit 25 is controlled by the microcomputer 100, and emits the light when the failure prediction/abnormality prediction outputting unit 105 outputs the failure prediction signal to the exterior and does not emit the light when the failure prediction/abnormality prediction outputting unit does not output the failure prediction signal to the exterior.

Next, an internal functional configuration of the microcomputer 100 will be described. It should be noted that the microcomputer 100 is provided with a CPU and a memory storing a program, and the CPU reads out the program from the memory, and the microcomputer functions to perform operation following the program.

The CPU provided with the microcomputer 100 includes a position detecting unit (a position detection means) 121, an ON/OFF output control unit 123, a mode switching unit (a mode switching means) 125, a time measuring unit (a time measurement means) 127, a correcting unit (a reference time setting means) 129, a reference time setting unit (a reference time setting means) 131, a comparing unit (a comparison means) 133, and a notifying unit (a notification means) 135.

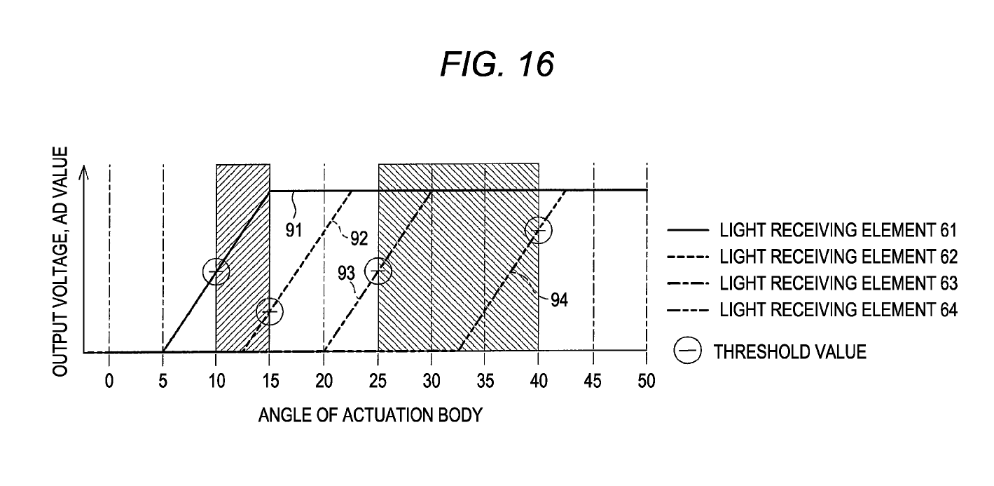

The position detecting unit 121 detects the position of the actuation body 7 by comparing the voltages respectively outputted by the light receiving elements 61 to 64 and reference times respectively preliminarily set for the light receiving elements 61 to 64. It should be noted that the position detecting unit 121 converts the voltages (analog values) outputted by the light receiving elements 61 to 64 into digital values, and compares the converted digital values and threshold values. It should be noted that the threshold values will be described with using FIG. 16.

FIG. 16 is a view showing relationships between the angle of the actuation body and the output voltage of the light receiving elements. As shown in FIG. 16, four sequential lines 91 to 94 indicate the relationships between the voltage respectively outputted by the light receiving elements 61 to 64 upon respectively receiving the lights from the light emitting elements 51 to 54, and the actuation body 7. The sequential line 91 corresponds to the light receiving element 61, the sequential line 92 corresponds to the light receiving element 62, the sequential line 93 corresponds to the light receiving element 63, and the sequential line 94 corresponds to the light receiving element 64.

As shown in FIG. 16, when the angle of the actuation body 7 is not less than 0 degree and less than 5 degrees, the lights respectively emitted by the light emitting elements 51 to 54 are blocked. When the angle of the actuation body 7 is not less than 12.5 degrees and less than 20 degrees, at least a part of the lights respectively emitted by the light emitting elements 51, 52 passes through, and the lights respectively emitted by the light emitting elements 53, 54 are blocked. When the angle of the actuation body 7 is not less than 20 degrees and less than 32.5 degrees, at least a part of the lights respectively emitted by the light emitting elements 51 to 53 passes through, and the lights respectively emitted by the light emitting element 54 is blocked. When the angle of the actuation body 7 is not less than 32.5 degrees and less than 50 degrees, at least a part of the lights respectively emitted by the light emitting elements 51 to 54 passes through. With the angle from 5 to 15 degrees, the output voltage from the light receiving element 61 is continuously increased in proportion to the angle. This is because size of the overlapping region of the opening of the second partition plate 81b corresponding to the light receiving element 61 and the slit 71 is increased in accordance with the increase in the angle. Similarly, the output voltage from the light receiving element 62 is continuously increased in proportion to the angle with the angle from 12.5 to 22.5 degrees, the output voltage from the light receiving element 63 is continuously increased in proportion to the angle with the angle from 20 to 30 degrees, and the output voltage from the light receiving element 64 is continuously increased in proportion to the angle with the angle from 32.5 to 42.5 degrees.

In such a way, in accordance with the increase in the angle of the actuation body 7, the light passing through the plunger 43 is increased. Conversely, in accordance with a decrease in the angle of the actuation body 7, the light passing through the plunger 43 is decreased. In such a way, the position of the plunger 43 is changed in accordance with the angle of the actuation body 7 from the fixed position, and the amounts of the lights respectively received by the light receiving elements 61 to 64 are differentiated in accordance with the position of the plunger 43.

In an angle range within which the output voltages from the light receiving elements 61 to 64 are continuously changed in accordance with the angle of the actuation body 7, the angle of the actuation body 7 can be detected by the output voltages of the light receiving elements 61 to 64. Thus, the output voltages of the angle to be detected is preliminarily set as the threshold values for the light receiving elements 61 to 64. In FIG. 16, marks that a horizontal line is included in a circle are respectively shown on lines of the sequential lines 91 to 94. The marks indicate the voltages of the threshold values respectively preliminarily set for the light receiving elements 61 to 64.

The sequential line 91 indicates that the voltage outputted by the light receiving element 61 by the light received from the light emitting element 51 is less than the threshold value when the actuation body 7 is at less than 10 degrees, and the above voltage is not less than the threshold value when the actuation body is at not less than 10 degrees. The sequential line 92 indicates that the voltage outputted by the light receiving element 62 by the light received from the light emitting element 52 is less than the threshold value when the actuation body 7 is at less than 15 degrees, and the above voltage is not less than the threshold value when the actuation body is at not less than 15 degrees. The sequential line 93 indicates that the voltage outputted by the light receiving element 63 by the light received from the light emitting element 53 is less than the threshold value when the actuation body 7 is at less than 25 degrees, and the above voltage is not less than the threshold value when the actuation body is at not less than 25 degrees. The sequential line 94 indicates that the voltage outputted by the light receiving element 64 by the light received from the light emitting element 54 is less than the threshold value when the actuation body 7 is at less than 40 degrees, and the above voltage is not less than the threshold value when the actuation body is at not less than 40 degrees.

From FIG. 16, it can be expressed that the positions (the light detection start positions) of the plunger 43 when the light receiving elements 61 to 64 start detecting the lights is different among the light receiving elements 61 to 64. Specifically, the light detection start position corresponding to the light receiving element 61 is a position of the plunger 43 when the actuation body 7 is placed at a position of 5 degrees, the light detection start position corresponding to the light receiving element 62 is a position of the plunger 43 when the actuation body 7 is placed at a position of 12.5 degrees, the light detection start position corresponding to the light receiving element 63 is a position of the plunger 43 when the actuation body 7 is placed at a position of 20 degrees, and the light detection start position corresponding to the light receiving element 64 is a position of the plunger 43 when the actuation body 7 is placed at a position of 32.5 degrees.

In such a way, a position where the light amount is maximum and the light detection start position are different among the light receiving elements 61 to 64. Thus, a position range of the plunger 43 when the light receiving elements 61 to 64 detect the light is also different.

It should be noted that in the above description of FIGS. 10 to 14, the front surface of the plunger 43 faces the light emitting elements 51 to 54, and the back surface of the plunger 43 faces the light receiving elements 61 to 64. However, conversely, the back surface of the plunger 43 may face the light emitting elements 51 to 54, and the front surface of the plunger 43 may face the light receiving elements 61 to 64. Even in this case, the relationships between the angle of the actuation body and the output voltage of the light receiving elements are the same as FIG. 16.

Back in FIG. 15, the position detecting unit 121 generates a first signal serving as a HIGH signal in a case where the voltage not less than the threshold value set for the light receiving element 61 is inputted from the light receiving element 61, that is, in a case where the actuation body 7 is placed at a position of not less than 10 degrees, and as a LOW signal in a case where the voltage less than the threshold value set for the light receiving element 61 is inputted from the light receiving element 61, that is, in a case where the actuation body 7 is placed at a position of less than 10 degrees. The position detecting unit 121 generates a second signal serving as a HIGH signal in a case where the voltage not less than the threshold value set for the light receiving element 62 is inputted from the light receiving element 62, that is, in a case where the actuation body 7 is placed at a position of not less than 15 degrees, and as a LOW signal in a case where the voltage less than the threshold value set for the light receiving element 62 is inputted from the light receiving element 62, that is, in a case where the actuation body 7 is placed at a position of less than 15 degrees. The position detecting unit 121 generates a third signal serving as a HIGH signal in a case where the voltage not less than the threshold value set for the light receiving element 63 is inputted from the light receiving element 63, that is, in a case where the actuation body 7 is placed at a position of not less than 25 degrees, and as a LOW signal in a case where the voltage less than the threshold value set for the light receiving element 63 is inputted from the light receiving element 63, that is, in a case where the actuation body 7 is placed at a position of less than 25 degrees. Further, the position detecting unit 121 generates a fourth signal serving as a HIGH signal in a case where the voltage not less than the threshold value set for the light receiving element 64 is inputted from the light receiving element 64, that is, in a case where the actuation body 7 is placed at a position of not less than 40 degrees, and as a LOW signal in a case where the voltage less than the threshold value set for the light receiving element 64 is inputted from the light receiving element 64, that is, in a case where the actuation body 7 is placed at a position of less than 40 degrees.

The position detecting unit 121 includes a first determination unit 141, and a second determination unit 143. The first determination unit 141 determines whether or not the actuation body 7 moves from a position of a larger angle than the second position to the second position. Here, a case where the second position is the position of 15 degrees which is the same as the third position will be taken as an example and described. In a case of this example, specifically, the first determination unit 141 determines whether or not the second signal is changed from HIGH to LOW, that is, whether or not the actuation body 7 is placed at the position of 15 degrees after the voltage larger than the threshold value set for the light receiving element 62 is inputted from the light receiving element 62. The first determination unit 141 determines that measurement of the time is started in a case where the second signal is changed from HIGH to LOW, and otherwise does not determine that the measurement of the time is started. When the first determination unit 141 determines that the measurement of the time is started, the first determination unit outputs a measurement start instruction indicating start of the measurement of the time to the time measuring unit 127. It should be noted that although the second position is the position of 15 degrees, the angle may be other angles as long as the position detecting unit 121 is capable of detecting. For example, in a case where the second position is set as a position of 25 degrees, the first determination unit 141 may use the third signal. In a case where the second position is set as a position of 40 degrees, the first determination unit 141 may use the fourth signal.

It should be noted that a signal switching unit for switching which signal among the second to fourth signals the first determination unit 141 uses may be provided. Thereby, the user can appropriately set the second position to any of 15 degrees, 25 degrees, and 40 degrees in accordance with the physical body with which the actuation body is brought into contact or the production line.

The first determination unit 141 determines whether or not the actuation body 7 moves from a position of a larger angle than the first position to the first position. Here, the first position is a position of 10 degrees. Therefore, specifically, the first determination unit 141 determines whether or not the first signal is changed from HIGH to LOW, that is, whether or not the actuation body 7 is placed at the position of 10 degrees after the voltage larger than the threshold value set for the light receiving element 61 is inputted from the light receiving element 61. The first determination unit 141 determines that the measurement of the time is finished in a case where the first signal is changed from HIGH to LOW, and otherwise does not determine that the measurement of the time is finished. When the first determination unit 141 determines that the measurement of the time is finished, the first determination unit outputs a measurement finishing instruction indicating finishing of the measurement of the time to the time measuring unit 127. It should be noted that although the first position is the position of 10 degrees, the angle may be other angles as long as the position detecting unit 121 is capable of detecting. However, there is a condition that the angle is smaller than the angle specified by the second position. For example, in a case where the second position is set as the position of 25 degrees, the first position may be set as the position of 15 degrees. In this case, the first determination unit 141 can output the measurement finishing instruction by using the second signal. In a case where the second position is set as the position of 40 degrees, the first position may be set as the position of 15 degrees or 25 degrees. In this case, the first determination unit 141 can output the measurement finishing instruction by using the second signal or the third signal.

It should be noted that a signal switching unit for switching which signal among the first to third signals the first determination unit 141 uses may be provided. Thereby, the user can appropriately set the first position to any of 15 degrees, 25 degrees, and 40 degrees in accordance with the physical body with which the actuation body is brought into contact or the production line.

The second determination unit 143 determines whether or not the actuation body 7 detects the third position (such as the position of 15 degrees). When the second determination unit 143 determines that the actuation body 7 detects the third position, the second determination unit outputs an ON output instruction indicating that the ON/OFF signal outputting unit 103 is allowed to output the ON signal to the ON/OFF output control unit 123, and otherwise, the second determination unit 143 outputs an OFF output instruction indicating that the ON/OFF signal outputting unit 103 is allowed to output the OFF signal to the ON/OFF output control unit 123.

Any of the ON output instruction and the OFF output instruction is inputted from the second determination unit 143 to the ON/OFF output control unit 123. When the ON output instruction is inputted from the second determination unit 143, the ON/OFF output control unit 123 outputs the ON signal to the ON/OFF signal outputting unit 103 and lights the lighting unit 21. When the OFF output instruction is inputted from the second determination unit 143, the ON/OFF output control unit 123 outputs the OFF signal to the ON/OFF signal outputting unit 103 and does not light the lighting unit 21.

The mode switching unit 125 switches the mode to any of the prediction mode and the learning mode. Specifically, when the user turns the mode switch 27 ON to thereby turn HIGH to LOW, the mode switching unit 125 switches the mode from the prediction mode to the learning mode. Here, the mode is switched from the prediction mode to the learning mode under a condition that the mode switch 27 is in the ON state for a predetermined time. The predetermined time is, for example, 2 seconds. When the mode is switched from the prediction mode to the learning mode, the mode switching unit 125 outputs a learning mode switching signal indicating that the mode is switched from the prediction mode to the learning mode to the time measuring unit 127 and the correcting unit 129.

When the user turns the mode switch 27 OFF to turn LOW to HIGH, the mode switching unit 125 switches the mode from the learning mode to the prediction mode. When the mode is switched from the learning mode to the prediction mode, the mode switching unit 125 outputs a prediction mode switching signal indicating that the mode is switched from the learning mode to the prediction mode to the time measuring unit 127 and the correcting unit 129.

Any of the learning mode switching signal and the prediction mode switching signal is inputted from the mode switching unit 125 to the time measuring unit 127, and the measurement start instruction and the measurement finishing instruction are inputted from the first determination unit 141 to the time measuring unit 127. When the measurement start instruction is inputted from the first determination unit 141, the time measuring unit 127 starts the measurement of the time. When the measurement finishing instruction is inputted from the first determination unit 141 after the measurement of the time is started, the time measuring unit 127 finishes the measurement of the time. In a case where a plurality of measurement start instructions and measurement finishing instructions is inputted from the first determination unit 141, the time is measured every time when the measurement start instruction is inputted, and the measurement of the time is finished every time when the measurement finishing instruction is inputted. Thereby, the time is measured as often as the measurement start instructions or the measurement finishing instructions are inputted.

In a case where the learning mode switching signal is inputted from the mode switching unit 125, the time measuring unit 127 outputs the measured time to the correcting unit 129 as a measured time for the learning mode. In a case where there is a plurality of times measured by the time measuring unit 127, a plurality of measured times for the learning mode is outputted to the correcting unit 129.

In a case where the prediction mode switching signal is inputted from the mode switching unit 125, the time measuring unit 127 outputs the measured time to the comparing unit 133 as a measured time for the prediction mode.

It should be noted that although switching from the learning mode to the prediction mode is an operation of turning the mode switch 27 OFF, the mode may be switched to the prediction mode after a lapse of a predetermined time after the mode is switched to the learning mode. In this case, the predetermined time is, for example, 30 minutes. The number of times the determination unit 141 determines that the measurement of the time is started or finished may be counted, and in a case where the counted number of times reaches the predetermined number of times, the mode may be switched from the learning mode to the prediction mode. In this case, the predetermined number of times is, for example, 30 times. Therefore, since the mode can be automatically switched from the learning mode to the prediction mode, time and effort for switching the mode by the user can be saved.

The plurality of measured times for the learning mode is inputted from the time measuring unit 127 to the correcting unit 129, and the learning mode switching signal and the prediction mode switching signal are inputted from the mode switching unit 125 to the correcting unit. The correcting unit 129 adds up the plurality of measured times for the learning mode inputted from the time measuring unit 127 in a time from when the learning mode switching signal is inputted from the mode switching unit 125 until when the prediction mode switching signal is inputted. The correcting unit 129 calculates an average time based on the number of the measured times for the learning mode inputted in the time from when the learning mode switching signal is inputted from the mode switching unit 125 until when the prediction mode switching signal is inputted, and the added-up time, and outputs the calculated average time to the reference time setting unit 131 as a first corrected time (a correction value). It should be noted that although the correcting unit 129 calculates the average time as the first corrected time, a maximum time among the plurality of measured times for the learning mode or a center value among the plurality of measured times for the learning mode may be calculated as the first corrected time.

The first corrected time (the time serving as an average of the plurality of times for the learning mode (hereinafter, referred to as the “average time”)) is inputted from the correcting unit 129 to the reference time setting unit 131. When the first corrected time is inputted from the correcting unit 129, the reference time setting unit 131 stores a time obtained by adding a predetermined time to the first corrected time inputted from the correcting unit 129 in the memory as the reference time T. It should be noted that although the correcting unit 129 adds the predetermined time, the reference time T may be calculated by multiplying the inputted first corrected time by a predetermined rate.

The measured times for the prediction mode are inputted from the time measuring unit 127 to the comparing unit 133. Every time when the measured time for the prediction mode is inputted from the time measuring unit 127, the comparing unit 133 extracts the reference time T stored in the memory, and compares the extracted reference time T and the measured time for the prediction mode. The comparing unit 133 outputs an instruction to notify of the failure prediction to the notifying unit 135 when the measured time for the prediction mode is longer than the reference time T, and otherwise, stands by until the next measured time for the prediction mode is inputted from the time measuring unit 127.

The instruction to notify of the failure prediction (an alarm) is inputted from the comparing unit 133 to the notifying unit 135. When the instruction to notify of the failure prediction is inputted from the comparing unit 133, the notifying unit 135 allows the failure prediction/abnormality prediction outputting unit 105 to output the failure prediction signal, and allows the lighting unit 25 to blink at a predetermined time interval. The predetermined time interval is 4 seconds.

### Use Example

Next, a specific use example of the limit switch 1 of the present embodiment will be described. A case where the user installs a new limit switch 1 in the production line will be taken as an example and described. It should be noted that the same is applied to a case where a type of the physical body to be moved in the production line is changed.

Firstly, the user installs the limit switch 1 in the production line. At this time, while confirming that the physical body to be moved is normally brought into contact with the actuation body 7 of the limit switch 1, an installment point of the limit switch 1 is adjusted. For example, the installment position is adjusted while supplying the electric power to the limit switch 1 and confirming that the ON signal is normally outputted from the terminal 33 when the physical body to be moved displaces the actuation body 7.

When installment of the limit switch 1 is completed, the user operates the production line and supplies the electric power to the limit switch 1. At this time, since the second determination unit 143 and the ON/OFF output control unit 123 are operated, the normal ON signal is outputted every time when the physical body is brought into contact with the actuation body 7.

While confirming that the normal ON signal is outputted, the user switches the mode to the learning mode by operating the mode switch 27. As a result, the mode switching unit 125 outputs the learning mode switching signal to the time measuring unit 127 and the correcting unit 129.

The time measuring unit 127 to which the learning mode switching signal is inputted measures a moving speed (returning speed) during the actuation body 7 moving from the second position to the first position, and outputs the measured times for the learning mode to the correcting unit 129. The correcting unit 129 adds up the received measured times for the learning mode.

Thereafter, the user switches the mode to the prediction mode by operating the mode switch 27. As a result, the mode switching unit 125 outputs the prediction mode switching signal to the time measuring unit 127 and the correcting unit 129. Alternatively, upon detecting that an elapsed time or the number of measurement times after the learning mode switching signal is received reaches a predetermined time or the predetermined number of times, the mode switching unit 125 may output the prediction mode switching signal to the time measuring unit 127 and the correcting unit 129.

The correcting unit 129 receiving the prediction mode switching signal outputs the first corrected time serving as the average value of the added-up value of the measured times for the learning mode received so far to the reference time setting unit 131.

The reference time setting unit 131 stores the time obtained by adding the predetermined time in the memory as the reference time T.

Meanwhile, the time measuring unit 127 receiving the prediction mode switching signal measures the moving speed (the returning speed) during the actuation body 7 moving from the second position to the first position, and outputs the measured time for the prediction mode to the comparing unit 133. The comparing unit 133 compares the measured time for the prediction mode and the reference time T updated in the memory, and outputs the instruction to notify of the failure prediction (the alarm) to the notifying unit 135 when the measured time for the prediction mode is longer than the reference time T. Thereby, the alarm is notified. Specifically, the failure prediction signal is outputted from the failure prediction/abnormality prediction outputting unit 105, and the lighting unit 25 blinks. Thereby, the fact that the moving speed (the returning speed) during the actuation body moving from the second position to the first position is slowed down can be recognized.

In such a way, when the actuation body 7 provided in the limit switch 1 is brought into contact with each of a plurality of physical bodies to be moved on the production line in the learning mode, the plurality of measured times for the learning mode is measured. The average time is calculated from the plurality of measured times for the learning mode, and the time obtained by adding the predetermined time to the calculated average time is set as the reference time T. Thereby, the reference time T can be set in accordance with size of the physical body to be brought into contact with the limit switch 1. Further, when the actuation body 7 provided in the limit switch 1 is brought into contact with each of the plurality of physical bodies to be moved on the production line in the prediction mode, the plurality of measured times for the prediction mode is measured. Every time when the measured time for the prediction mode is measured, the reference time T and the measured time for the prediction mode are compared. When the measured time for the prediction mode is longer than the reference time T, the failure prediction is notified. The reference time T is a time set based on the plurality of physical bodies to be moved on the production line. Thus, when the measured time for the prediction mode is longer than the reference time T, this is highly possibly not due to contact between the limit switch 1 and the physical body. That is, the failure highly possibly occurs in the limit switch 1. Therefore, by setting the reference time T based on the plurality of physical bodies to be moved on the production line, a probability that the failure is notified when the failure occurs in the limit switch 1 can be enhanced.

### Modified Example

In the present embodiment, the plunger 43 provided in the limit switch 1 has the slits 71 to 74 as shown in FIG. 4. In a modified example, the plunger 43 provided in the limit switch 1 is replaced with a plunger 43A having a plurality of slits formed into a different shape from the slits 71 to 74. The plunger 43A will be mainly described.

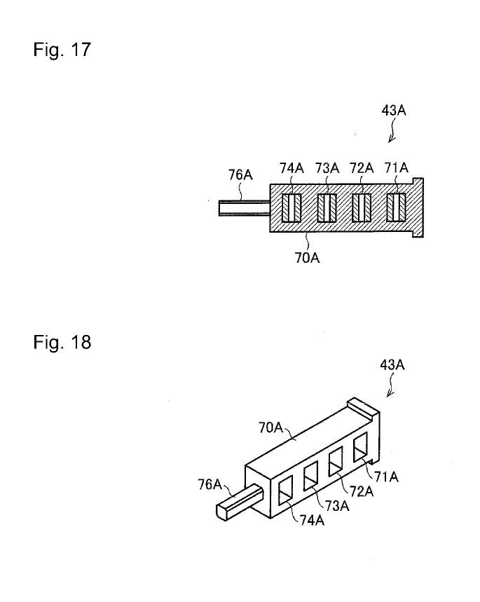

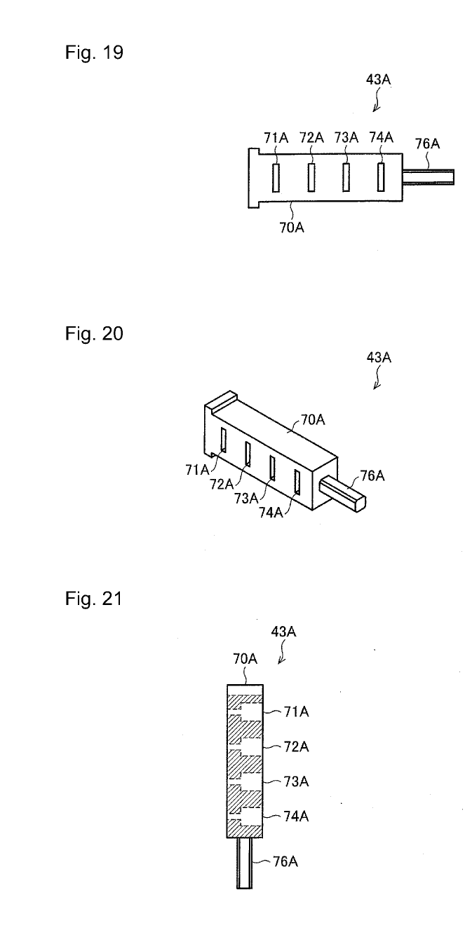

FIG. 17 is a view showing a front surface of the plunger in the modified example. FIG. 18 is a perspective view showing the front surface of the plunger in the modified example. FIG. 19 is a view showing a back surface of the plunger in the modified example. FIG. 20 is a perspective view showing the back surface of the plunger in the modified example. FIG. 21 is a view showing a cross section of the plunger in the modified example. As shown in FIGS. 17 to 21, the plunger 43A has a main body portion 70A and a projection portion 76A.

The projection portion 76A is combined with the main body portion 70A and is thinner than the main body portion 70A. The projection portion 76A is inserted into the coil spring 42. The projection portion 76A is inserted into the provided in the third partition plate 81c as well as the projection portion 76. When the plunger 43A moves in parallel toward the third partition plate 81c in accordance with the movement of the actuation body 7, the coil spring 42 is compressed between the main body portion 70A of the plunger 43A and the third partition plate 81c so as to give force of returning the plunger 43A to the reference position to the plunger 43A.

The main body portion 70A has slits 71A to 74A. Here, since shapes of the slits 71A to 74A are the same, the slit 71A will be described. An opening of the slit 71A has different sizes respectively for the front surface and the back surface of the plunger 43A. Specifically, a shape of the opening of the slit 71A in the cross section is a shape of regions not indicated by diagonal lines among a region surrounded by broken lines as shown in FIG. 17. The size of the opening of the slit 71A on the front surface of the plunger 43A is set to be larger than the size of the opening of the slit 71A on the back surface of the plunger 43A.

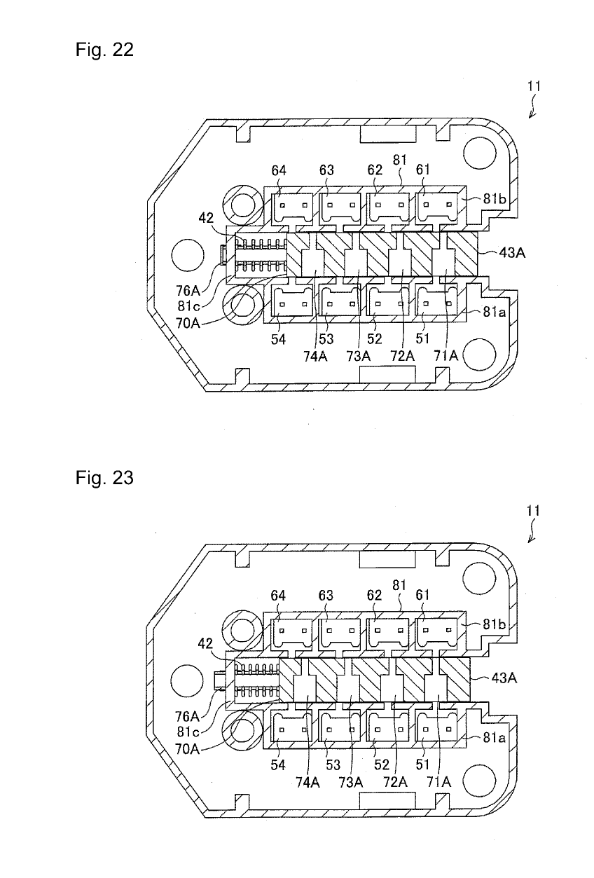

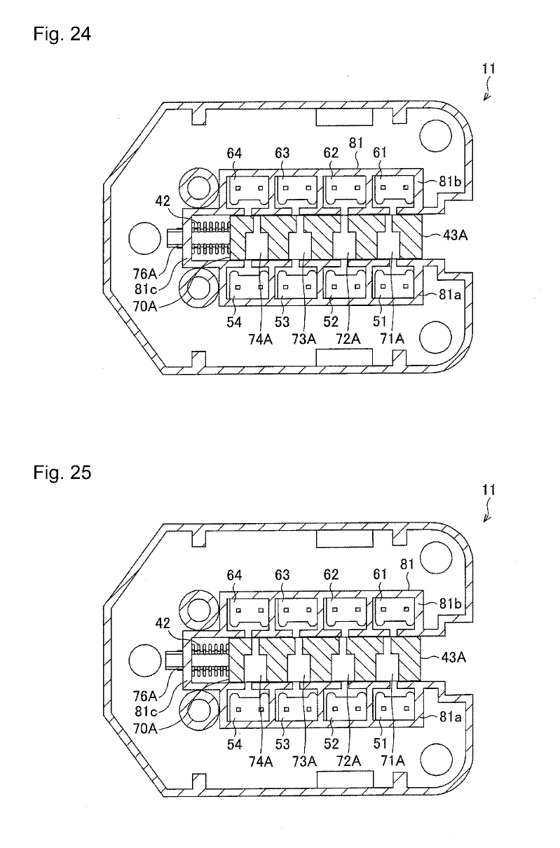

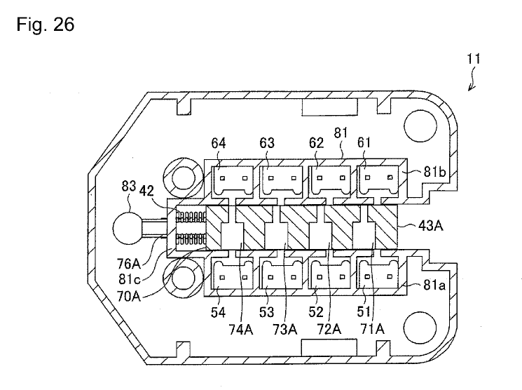

FIGS. 22 to 26 are views showing positional relationships among the plurality of light emitting elements, the plurality of light receiving elements, and the plunger in the modified example in the cross section of the switch module. It should be noted that FIG. 22 is a view when the actuation body 7 is placed at the fixed position, FIG. 23 is a view when the actuation body 7 is placed at the position of 15 degrees, FIG. 24 is a view when the actuation body 7 is placed at the position of 22.5 degrees, FIG. 25 is a view when the actuation body 7 is placed at the position of 30 degrees, and FIG. 26 is a view when the actuation body 7 is placed at the position of 42.5 degrees. The positions at which the light emitting elements 51 to 54, the light receiving elements 61 to 64, and the partition plate 81 are disposed are the same as FIG. 10.

As shown in FIGS. 22 to 26, the front surface of the plunger 43 faces the light emitting elements 51 to 54, and the back surface of the plunger 43 faces the light receiving elements 61 to 64. It should be noted that as shown in FIG. 21, a part of the main body portion 70A of the plunger 43A other than the slits 71A to 74A is indicated by diagonal lines. The part of the diagonal lines serves as the light blocking region.

As well as the plunger 43, the position of the plunger 43A is changed in conjunction with the movement of the actuation body 7, and the lights emitted by the light emitting elements 51 to 54 are blocked or pass through in accordance with a change in the position. Specifically, in the plunger 43A, in the middle of movement of the plunger 43A, the slits 71A to 74A are respectively formed in the plunger 43A so as to be overlapped with the openings of the first partition plate 81a corresponding to the light emitting elements 51 to 54 and the openings of the second partition plate 81b corresponding to the light receiving elements 61 to 64.

As well as the slits 71 to 74, a distance between each of the openings on the back surface side of the slits 71A to 74A and each of the openings of the second partition plate 81b corresponding to the slits is different among the slits 71A to 74A. Specifically, as shown in FIG. 22, positions of the slits 71A to 74A are set in such a manner that when the actuation body 7 is placed at the fixed position (that is, when the plunger 43A is placed at the reference position), the distance is gradually increased in the order of a distance between the opening on the back surface side of the slit 71A and the opening of the second partition plate 81b corresponding to the slit 71A, a distance between the opening on the back surface side of the slit 72A and the opening of the second partition plate 81b corresponding to the slit 72A, a distance between the opening on the back surface side of the slit 73A and the opening of the second partition plate 81b corresponding to the slit 73A, and a distance between the opening on the back surface side of the slit 74A and the opening of the second partition plate 81b corresponding to the slit 74A.

Hereinafter, with reference to FIGS. 22 to 26, as the rotation angle of the actuation body 7 from the fixed position is changed, how presence or absence of the light incidence on the light receiving elements 61 to 64 and the amounts of the incident light are changed will be described.

As shown in FIG. 22, the plunger 43A blocks all the lights emitted by the light emitting elements 51 to 54 when the actuation body 7 is placed at the position of 0 degree (the fixed position). Therefore, the lights respectively emitted by the light emitting elements 51 to 54 are blocked by the plunger 43A and does not reach the light receiving elements 61 to 64.

From a state shown in FIG. 22, the actuation body 7 is rotated, and the plunger 43A is moved in the longitudinal direction thereof. At this time, as described above, the distance between the opening on the back surface side of the slit 71A and the opening of the second partition plate 81b corresponding to the slit 71A is shorter than the distances corresponding to the other slits 72A to 74A. Thus, only the opening on the back surface side of the slit 71A and the opening of the second partition plate 81b corresponding to the light receiving element 61 start overlapping. Thereafter, when a movement amount of the plunger 43A is increased with the increase in the angle of the actuation body 7, an overlapping region of the opening on the back surface side of the slit 71A and the opening of the second partition plate 81b corresponding to the light receiving element 61 is increased, and the opening on the back surface side of the slit 72A and the opening of the second partition plate 81b corresponding to the light receiving element 62 start overlapping.

As shown in FIG. 23, in a case where the actuation body 7 is placed at the position of 15 degrees, the opening on the back surface side of the slit 71A matches with the opening of the second partition plate 81b corresponding to the light receiving element 61. In other words, the slit 71A exists all over the space (the light path region) linearly connecting the opening corresponding to the position at which the light emitting element 51 is disposed in the first partition plate 81a and the opening corresponding to the position at which the light receiving element 61 is disposed in the second partition plate 81b. At this time, the opening on the back surface side of the slit 72A is overlapped with part of the opening of the second partition plate 81b corresponding to the light receiving element 62. Therefore, a light receiving amount of the light receiving element 61 has a maximum value, and the light receiving element 62 receives only part of the light emitted from the light emitting element 52. In this stage, the light blocking region of the plunger 43A still covers the openings corresponding to the positions at which the light receiving elements 63, 64 are disposed. Therefore, the light does not reach the light receiving elements 63, 64.

From a state shown in FIG. 23, the actuation body 7 is further rotated, and the plunger 43A is moved in the longitudinal direction thereof. At this time, when the movement amount of the plunger 43A is increased, an overlapping area of the opening on the back surface side of the slit 71A and the opening of the second partition plate 81b corresponding to the light receiving element 61 is decreased, and an overlapping area of the opening on the back surface side of the slit 72A and the opening of the second partition plate 81b corresponding to the light receiving element 62 is increased. The opening on the back surface side of the slit 73A and the opening of the second partition plate 81b corresponding to the light receiving element 63 start overlapping.

As shown in FIG. 24, when the actuation body 7 is placed at the position of 22.5 degrees, the opening on the back surface side of the slit 72A matches with the opening of the second partition plate 81b corresponding to the light receiving element 62. The openings on the back surface side of the slits 71A, 73A are respectively overlapped with part of the openings of the second partition plate 81b corresponding to the light receiving elements 61, 63. Therefore, the light receiving amount of the light receiving element 62 has a maximum value, and the lights emitted by the light emitting elements 51, 53 partially pass through the slits 71A, 73A, and reach the light receiving elements 61, 63. It should be noted that in this stage, the light blocking region of the plunger 43A still covers the opening corresponding to the position at which the light receiving element 64 is disposed. Therefore, the light does not reach the light receiving element 64.

From a state shown in FIG. 24, the actuation body 7 is further rotated, and the plunger 43A is moved in the longitudinal direction thereof. At this time, when the movement amount of the plunger 43A is increased, the light blocking region covers the opening of the second partition plate 81b corresponding to the light receiving element 61. The overlapping area of the opening on the back surface side of the slit 72A and the opening of the second partition plate 81b corresponding to the light receiving element 62 is decreased. Further, an overlapping area of the opening on the back surface side of the slit 73A and the opening of the second partition plate 81b corresponding to the light receiving element 63 is increased.

As shown in FIG. 25, when the actuation body 7 is placed at the position of 30 degrees, the opening of the second partition plate 81b corresponding to the light receiving element 61 is completely covered by the light blocking region again. The opening on the back surface side of the slit 72A is overlapped with part of the opening of the second partition plate 81b corresponding to the light receiving element 62. Further, the opening on the back surface side of the slit 73A matches with the opening of the second partition plate 81b corresponding to the light receiving element 63. Therefore, the light does not reach the light receiving element 61, the light receiving amount of the light receiving element 63 has a maximum value, and the light emitted by the light emitting element 52 partially passes through the slit 72A, and reach the light receiving element 62. It should be noted that in this stage, the light blocking region of the plunger 43A still covers the opening corresponding to the position at which the light receiving element 64 is disposed. Therefore, the light does not reach the light receiving element 64.

From a state shown in FIG. 25, the actuation body 7 is further rotated, and the plunger 43A is moved in the longitudinal direction thereof. At this time, when the movement amount of the plunger 43A is increased, the light blocking region covers the opening of the second partition plate 81b corresponding to the light receiving element 62. The overlapping area of the opening on the back surface side of the slit 73A and the opening of the second partition plate 81b corresponding to the light receiving element 63 is decreased. Further, the opening on the back surface side of the slit 74A and the opening of the second partition plate 81b corresponding to the light receiving element 64 start overlapping.

As shown in FIG. 26, when the actuation body 7 is placed at the position of 42.5 degrees, the openings of the second partition plate 81b corresponding to the light receiving elements 61, 62 are completely covered by the light blocking region again. The opening on the back surface side of the slit 73A is overlapped with part of the opening of the second partition plate 81b corresponding to the light receiving element 63. Further, the opening on the back surface side of the slit 74A matches with the opening of the second partition plate 81b corresponding to the light receiving element 64. Therefore, the light does not reach the light receiving elements 61, 62, the light receiving amount of the light receiving element 64 has a maximum value, and the light emitted by the light emitting element 53 partially passes through the slit 73A, and reach the light receiving element 63.

It should be noted that the actuation body 7 can be displaced by the angle from 42.5 degrees to 50 degrees. However, when the actuation body 7 is placed at the angle of 42.5 degrees, the plunger 43A is brought into contact with a fixing member 83. Therefore, when the actuation body 7 is placed at the angle from the 42.5 degrees to 50 degrees, the plunger 43A is in the same state as FIG. 26.

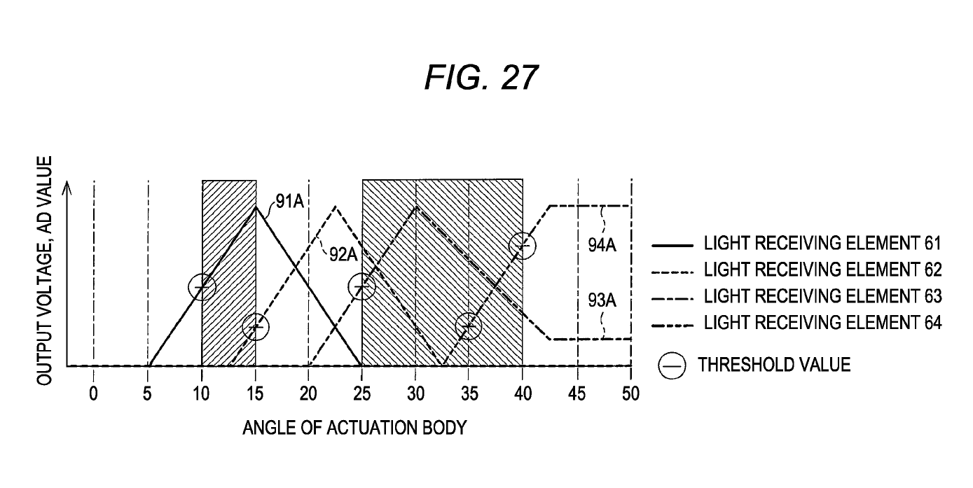

FIG. 27 is a view showing relationships between the angle of the actuation body and the output voltage of the light receiving elements in the modified example. As shown in FIG. 27, four sequential lines 91A to 94A indicate relationships between the voltages respectively outputted by the light receiving elements 61 to 64 upon respectively receiving the lights from the light emitting elements 51 to 54, and the angles of the actuation body 7. The sequential line 91A corresponds to the light receiving element 61, the sequential line 92A corresponds to the light receiving element 62, the sequential line 93A corresponds to the light receiving element 63, and the sequential line 94A corresponds to the light receiving element 64.

The sequential line 91A indicates that the light receiving element 61 receives the light from the light emitting element 51 when the actuation body 7 is placed at a position of not less than 5 degrees and not more than 25 degrees. The sequential line 92A indicates that the light receiving element 62 receives the light from the light emitting element 52 when the actuation body 7 is placed at a position of not less than 12.5 degrees and not more than 32.5 degrees. The sequential line 93A indicates that the light receiving element 63 receives the light from the light emitting element 53 when the actuation body 7 is placed at a position of not less than 20 degrees. The sequential line 94A indicates that the light receiving element 64 receives the light from the light emitting element 54 when the actuation body 7 is placed at a position of not less than 32.5 degrees. Marks that a horizontal line is included in a circle are respectively shown on lines of the sequential lines 91A to 94A. The marks indicate the voltages of the threshold values respectively for the light receiving elements 61 to 64.

The sequential line 91A indicates that the voltage outputted by the light receiving element 61 by the light received from the light emitting element 51 is less than the threshold value when the angle of the actuation body 7 is less than 10 degrees or larger than 20 degrees, and the above voltage is not less than the threshold value when the angle is not less than 10 degrees and not more than 20 degrees. The sequential line 92A indicates that the voltage outputted by the light receiving element 62 by the light received from the light emitting element 52 is less than the threshold value when the angle of the actuation body 7 is less than 15 degrees or larger than 30 degrees, and the above voltage is not less than the threshold value when the angle is not less than 15 degrees and not more than 30 degrees. The sequential line 93A indicates that the voltage outputted by the light receiving element 63 by the light received from the light emitting element 53 is less than the threshold value when the angle of the actuation body 7 is less than 25 degrees or larger than 37.5 degrees, and the above voltage is not less than the threshold value when the angle is not less than 25 degrees and not more than 37.5 degrees. The sequential line 94A indicates that the voltage outputted by the light receiving element 64 by the light received from the light emitting element 54 is less than the threshold value when the angle of the actuation body 7 is less than 35 degrees or larger than 40 degrees, and the above voltage is not less than the threshold value when the angle is not less than 35 degrees and not more than 40 degrees.

It should be noted that in the above description of FIGS. 22 to 26, the front surface of the plunger 43A faces the light emitting elements 51 to 54, and the back surface of the plunger 43A faces the light receiving elements 61 to 64. However, conversely, the back surface of the plunger 43A may face the light emitting elements 51 to 54, and the front surface of the plunger 43A may face the light receiving elements 61 to 64. Even in this case, the relationships between the angle of the actuation body and the output voltage of the light receiving elements are the same as FIG. 27.

In such a way, even in the present modified example, since the amounts of the light incident on the light receiving elements 61 to 64 are differentiated by the position of the plunger 43A, the voltages outputted from the light receiving elements 61 to 64 are changed. Therefore, by preliminarily setting the threshold value in the angle range of the actuation body 7 within which the outputted voltage is continuously changed, the angle of the actuation body 7 with which the voltage of the threshold value is outputted can be detected. Therefore, a returning time from the second position to the first position can be measured as well as the above embodiment.

In the above description, the limit switch 1 detects the position of the actuation body 7 by specifying the light receiving element receiving the light from the light emitting elements 51 to 54 among the light receiving elements 61 to 64 provided in the photointerrupter unit 41. However, a method of detecting the position of the actuation body 7 is not limited to the method in which the photointerrupter unit is used. As another method of detecting the position of the actuation body 7, for example, contact mechanisms capable of respectively detecting a plurality of positions of the actuation body 7 as described in Patent Document 1 may be used.

In accordance with rotation operation of the actuation body 7 provided in the limit switch 1, the position of the plunger 43, 43A is displaced. However, the present invention is not limited to the method by which the position of the plunger 43, 43A is displaced in conjunction with the rotation operation of the actuation body 7. As a method of displacing the position of the plunger 43, 43A by operation other than the rotation operation of the actuation body 7, for example, the method described in Non-patent Document 1 may be utilized.

As described above, a switch of the present invention provided with an actuation body to be displaced due to contact with a physical body and operated in accordance with a position of the actuation body includes a mode switching means for switching a mode to any of a learning mode and a prediction mode, a position detection means for detecting at least preliminarily fixed first and second positions of the actuation body, a time measurement means for measuring a time from when the first position is detected by the position detection means until when the second position is detected by the position detection means, a reference time setting means for setting a reference time based on the time measured by the time measurement means in the learning mode, a comparison means for comparing the time measured by the time measurement means and the reference time in the prediction mode, and a notification means for notifying of an alarm in a case where the measured time is greater than the reference time as a result of comparison by the comparison means in the prediction mode.

Further, in the switch of the present invention, the reference time setting means sets a time obtained by adding a predetermined time to a correction value corrected based on a plurality of times measured by the time measurement means as the reference time in the learning mode.

According to the above configuration, the correction value corrected based on the plurality of measured times serves as the reference time. Thus, a time in consideration with an individual difference of the physical body and the like can be set.

Further, in the switch of the present invention, the reference time setting means sets a time obtained by adding a predetermined time to a correction value corrected based on a plurality of times measured by the time measurement means as the reference time in the learning mode.

The reference time setting means sets a time obtained by multiplying a correction value corrected based on a plurality of times measured by the time measurement means by a predetermined rate as the reference time in the learning mode.

According to the above configuration, the time obtained by adding the predetermined time to the correction value is set as the reference time or the time obtained by multiplying the correction value by the predetermined rate is set as the reference time. That is, a time greater than the actually-measured time is set as the reference time. Thus, slowing-down of moving speed of the actuation body can be detected at an earlier stage.

Further, in the switch of the present invention, preferably, in a case where the mode is switched from the prediction mode to the learning mode, the mode switching means switches the mode from the learning mode to the prediction mode after a lapse of a predetermined time after the mode is switched to the learning mode.

Alternatively, in the switch of the present invention, in a case where the mode is switched from the prediction mode to the learning mode, the mode switching means may switch the mode from the learning mode to the prediction mode when the number of times the time is measured by the time measurement means reaches not less than the predetermined number of times in the learning mode.

According to the above configuration, in a case where the mode is switched from the prediction mode to the learning mode, the mode is automatically switched from the learning mode to the prediction mode after that. Therefore, the time and the effort for switching the mode by the user can be saved. Even when the user forgets to switch the mode to the prediction mode, the mode can be automatically switched to the prediction mode.

Further, in the switch of the present invention, a position of the actuation body when the actuation body is not in contact with the physical body is a fixed position, a movement amount from the fixed position to the first position is greater than a movement amount from the fixed position to the second position, and the time measurement means starts measurement of the time when the first position is detected after a more distant position from the fixed position than the first position is detected, and finishes the measurement of the time when the second position is detected.

Displacement speed of the actuation body is influenced by the frictional force between the actuation body and an attachment point thereof. Therefore, it is thought that due to an increase in the frictional force over a long time, returning speed of the actuation body for returning to the fixed position after the actuation body is brought into contact with the physical body is slowed down. However, according to the above configuration, the returning speed of the actuation body from the first position to the second position can be measured, and slowing-down of the returning speed can be detected so as to issue the alarm.

Further, the switch of the present invention preferably includes a displacement member to be displaced in conjunction with displacement of the actuation body, a light emitting element for emitting light from a light emitting surface, and a light receiving element having a light receiving surface facing the light emitting surface, the light receiving element for outputting a characteristic amount indicating an amount of the light incident on the light receiving surface, wherein the displacement member is disposed between the light emitting surface and the light receiving surface, an opening through which the light passes is formed in the displacement member in such a manner that the amount of the light incident on the light receiving surface among the light emitted from the light emitting surface is changed in accordance with displacement of the displacement member, and the position detection means preliminarily stores a first characteristic amount serving as a characteristic amount outputted from the light receiving element when the actuation body is placed at the first position and a second characteristic amount serving as a characteristic amount outputted from the light receiving element when the actuation body is placed at the second position, and detects the first position and the second position by comparing the characteristic amount outputted from the light receiving element, and the first characteristic amount and the second characteristic amount.

In a case where the positions are detected by contact with the actuation body or the displacement member, there is likelihood that a problem that the positions cannot be normally detected due to a failure of the contact is generated. There is also a problem that adjustment of a contact position thereof takes time. However, according to the above configuration, by using the characteristic amount outputted from the light receiving element, the first position and the second position can be detected in a non-contact state with the actuation body and the displacement member. As a result, the first position and the second position can be reliably detected. Only by preliminarily setting the first characteristic amount serving as the characteristic amount outputted from the light receiving element when the actuation body is placed at the first position and the second characteristic amount serving as the characteristic amount outputted from the light receiving element when the actuation body is placed at the second position, the first position and the second position can be easily detected without the adjustment of the contact position as in a conventional example.

The present invention is not limited to the above embodiment but various modifications can be achieved within a range described in the claims. An embodiment obtained by appropriately combining techniques respectively disclosed in different modes is also included in a technical scope of the present invention.

### INDUSTRIAL APPLICABILITY

The present invention can be utilized as a limit switch used in a production line or the like.

### DESCRIPTION OF SYMBOLS

1: Limit switch
3: Casing
5: Installment block
7: Actuation body
9: Screw
11: Switch module
21, 23, 25: Lighting unit
27: Mode switch
31 to 34: Terminal
41: Photointerrupter unit
43, 43A: Plunger
51 to 54: Light emitting element
61 to 64: Light receiving element
100: Microcomputer
101: Low voltage circuit
103: ON/OFF signal outputting unit
105: Failure prediction/abnormality prediction outputting unit
121: Position detecting unit
123: ON/OFF output control unit
125: Mode switching unit (mode switching means)
127: Time measuring unit (time measurement means)
129: Correcting unit (reference time setting means)
131: Reference time setting unit (reference time setting means)
133: Comparing unit (comparison means)
135: Notifying unit (notification means)
141: First determination unit
143: Second determination unit

1. A switch provided with an actuation body to be displaced due to contact with a physical body and operated in accordance with a position of the actuation body, comprising:
a mode switching means for switching a mode to any of a learning mode and a prediction mode;
a position detection means for detecting at least preliminarily fixed first and second positions of the actuation body;
a time measurement means for measuring a time from when the first position is detected by the position detection means until when the second position is detected by the position detection means;
a reference time setting means for setting a reference time based on the time measured by the time measurement means in the learning mode;
a comparison means for comparing the time measured by the time measurement means and the reference time in the prediction mode; and
a notification means for notifying of an alarm in a case where the measured time is greater than the reference time as a result of comparison by the comparison means in the prediction mode.

2. The switch according to claim 1, wherein the reference time setting means sets a correction value corrected based on a plurality of times measured by the time measurement means as the reference time in the learning mode.

3. The switch according to claim 1, wherein the reference time setting means sets a time obtained by adding a predetermined time to a correction value corrected based on a plurality of times measured by the time measurement means as the reference time in the learning mode.

4. The switch according to claim 1, wherein the reference time setting means sets a time obtained by multiplying a correction value corrected based on a plurality of times measured by the time measurement means by a predetermined rate as the reference time in the learning mode.

5. The switch according to claim 1, wherein in a case where the mode is switched from the prediction mode to the learning mode, the mode switching means switches the mode from the learning mode to the prediction mode after a lapse of a predetermined time after the mode is switched to the learning mode.

6. The switch according to claim 1, wherein in a case where the mode is switched from the prediction mode to the learning mode, the mode switching means switches the mode from the learning mode to the prediction mode when the number of times the time is measured by the time measurement means reaches not less than the predetermined number of times in the learning mode.

7. The switch according to claim 1, wherein a position of the actuation body when the actuation body is not in contact with the physical body is a fixed position,
a movement amount from the fixed position to the first position is greater than a movement amount from the fixed position to the second position,
and the time measurement means starts measurement of the time when the first position is detected after a more distant position from the fixed position than the first position is detected, and finishes the measurement of the time when the second position is detected.

8. The switch according claim 1, further comprising:
a displacement member to be displaced in conjunction with displacement of the actuation body;
a light emitting element for emitting light from a light emitting surface; and
a light receiving element having a light receiving surface facing the light emitting surface, the light receiving element for outputting a characteristic amount indicating an amount of the light incident on the light receiving surface, wherein
the displacement member is disposed between the light emitting surface and the light receiving surface,
an opening through which the light passes is formed in the displacement member in such a manner that the amount of the light incident on the light receiving surface among the light emitted from the light emitting surface is changed in accordance with displacement of the displacement member, and
the position detection means preliminarily stores a first characteristic amount serving as a characteristic amount outputted from the light receiving element when the actuation body is placed at the first position and a second characteristic amount serving as a characteristic amount outputted from the light receiving element when the actuation body is placed at the second position, and detects the first position and the second position by comparing the characteristic amount outputted from the light receiving element, and the first characteristic amount and the second characteristic amount.
